(19) United States
(12) Patent Application Publication
(10) Pub. No.: US 2026/0343687 A1
(43) Pub. Date: Oct. 29, 2026

(54) VOLTAGE COMPENSATION FOR INDUCTION COOKING CONTROL

(71) Applicant: Haier US Appliance Solutions, Inc., Wilmington, DE (US)

(72) Inventors: Nathaniel Lehrer, Louisville, KY (US); Jonah Connelly, Louisville, KY (US); Ali Jordan Faraji-Tajrishi, Louisville, KY (US)

(21) Appl. No.: 19/187,197

(22) Filed: Apr. 23, 2025

(51) Int. Cl. H05B 6/08; H05B 6/06

(52) U.S. Cl. CPC H05B 6/08; H05B 6/062

(57) ABSTRACT

A method for estimating a line current in an induction heating system is provided. The method includes determining a line current estimation based at least in part on a coil current sampling routine performed during a current sampling time period, the coil current sampling routine corresponding to a line cycle peak. The method further includes determining a first line voltage value based at least in part on one or more first line voltage measurements sampled during the current sampling time period. The method further includes determining a second line voltage value based at least in part on one or more second line voltage measurements. The method further includes determining an adjusted line current estimation based at least in part on the line current estimation, the first line voltage value, and the second line voltage value.

### FIELD

Example aspects of the present disclosure relate generally to induction heating systems for induction cooking appliances, and more specifically to estimating one or more electrical characteristics of an induction heating system of an induction cooking appliance.

### BACKGROUND

Induction cooking appliances (e.g., induction cook-tops) heat conductive cookware by magnetic induction. An induction heating system of an induction cooking appliance applies radio frequency current to a heating coil to generate a strong radio frequency magnetic field on the heating coil. When a conductive vessel, such as a pan, is placed over the heating coil, the magnetic field coupling from the heating coil generates eddy currents on the vessel, causing the vessel to increase in temperature.

### SUMMARY

Aspects and advantages of embodiments of the present disclosure will be set forth in part in the following description, or can be learned from the description, or can be learned through practice of the embodiments.

One example aspect of the present disclosure is directed to a method for estimating a line current in an induction heating system. The method includes determining a line current estimation based at least in part on a coil current sampling routine performed during a current sampling time period, the coil current sampling routine corresponding to a line cycle peak. The method further includes determining a first line voltage value based at least in part on one or more first line voltage measurements sampled during the current sampling time period. The method further includes determining a second line voltage value based at least in part on one or more second line voltage measurements. The method further includes determining an adjusted line current estimation based at least in part on the line current estimation, the first line voltage value, and the second line voltage value.

Another example aspect of the present disclosure is directed to an induction heating system of an induction cooking appliance. The induction heating system includes an induction coil configured to inductively heat a load. The induction heating system further includes an inverter configured to provide power to the induction coil. The induction heating system further includes a controller. The controller is configured to determine a line current estimation based at least in part on a coil current sampling routine performed during a current sampling time period, the coil current sampling routine corresponding to a line cycle peak. The controller is further configured to determine a first line voltage value based at least in part on one or more first line voltage measurements sampled during the current sampling time period. The controller is further configured to determine a second line voltage value based at least in part on one or more second line voltage measurements. The controller is further configured to determine an adjusted line current estimation based at least in part on the line current estimation, the first line voltage value, and the second line voltage value.

Another example aspect of the present disclosure is directed to an induction cooking appliance. The induction cooking appliance includes a user interface. The induction cooking appliance further includes an induction heating system. The induction heating system includes an induction coil configured to inductively heat a load. The induction heating system further includes an inverter configured to provide power to the induction coil. The induction heating system further includes a controller. The controller is configured to determine a line current estimation based at least in part on a coil current sampling routine performed during a current sampling time period, the coil current sampling routine corresponding to a line cycle peak. The controller is further configured to determine a first line voltage value based at least in part on one or more first line voltage measurements sampled during the current sampling time period. The controller is further configured to determine a second line voltage value based at least in part on one or more second line voltage measurements. The controller is further configured to determine an adjusted line current estimation based at least in part on the line current estimation, the first line voltage value, and the second line voltage value.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a perspective view of an example induction cooking appliance according to example embodiments of the present disclosure;

FIG. 2 provides a block diagram of an example induction heating system according to example embodiments of the present disclosure;

FIGS. 3A and 3B provide graphical representations of example signals of the induction heating system according to example embodiments of the present disclosure;

FIG. 4 depicts a schematic implementation of an example control scheme of an induction heating system according to example embodiments of the present disclosure;

FIG. 5 provides a graphical representation of example line voltages according to example embodiments of the present disclosure; and

FIG. 6 depicts a method for estimating a line current in an induction heating system.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

An induction heating system of an induction cooking appliance may be configured to control one or more electrical characteristics (e.g., line current, power output, etc.) of the heating system by sampling the behavior of the coil current at the peak of the line voltage cycle (e.g., 60 Hertz [Hz] line voltage cycle). At the peak, a generally sinusoidal signal amplitude of the coil current may be the greatest, and a more robust sensor signal with respect to system noise may be provided.

Some induction heating systems may estimate a line voltage value, (e.g., root mean square (RMS) line voltage) based on a singular, instantaneous line voltage measurement sampled at the peak of the line voltage cycle. This estimated RMS line voltage may assume a sinusoidal line voltage waveform that is un-skewed and maintains a √2 ratio between the peak value and the RMS (root-mean-squared) voltage. Accordingly, line voltage irregularities (e.g. voltage fluctuation, irregular shape, etc.) over the line voltage cycle may cause inaccuracy in an RMS line voltage estimated from a singular instantaneous line voltage measurement sampled at the peak of the line voltage cycle.

For systems that sample the induction coil current near the peak of the line voltage cycle, the accuracy of the total line current and/or power estimation may be improved by measuring the RMS voltage of the line voltage and sampling the line voltage during the coil current sampling. By tracking these parameters, irregularities in the line voltage shape and amplitude may be accounted for, thereby reducing inaccuracies in system control and improving the consistency of system performance over different line voltage characteristics.

One example aspect of the present disclosure is a method for estimating a line current in an induction heating system. A line current estimation may be determined based on, for instance, a coil current sampling routine performed during a current sampling time period corresponding to a line cycle peak. The line current estimation may be adjusted based on one or more line voltage values. For example, a first line voltage value (e.g., peak line voltage value) may be determined based on one or more first line voltage measurements sampled during the current sampling time period. In addition, a second line voltage value (e.g., RMS line voltage value) may be determined based at least in part on one or more second line voltage measurements. A correction factor incorporating the first and second line voltage value may then be applied to the line current estimation to determine an adjusted line current estimation. See below an example correction factor equation for determining an adjusted line current estimation:

$${I}_{line , corrected} = {I}_{line , sample} * \frac{\sqrt{2} * {V}_{System}}{{V}_{peak}} * \frac{{V}_{RMS}}{{V}_{System}}$$

As shown above, an adjusted line current estimation (I_{line,corrected}) may be determined based at least in part on the initial line current estimation (I_{line,sample}), the first line voltage value_{(V peak}), and the second line voltage value (V_{RMS}). Specifically, the correction factor may include an amplitude correction term

$$( e . g . , \frac{\sqrt{2} * {V}_{System}}{{V}_{peak}} )$$

and a current scaling term

$$( e . g . , \frac{{V}_{RMS}}{{V}_{System}} )$$

to compensate for irregularities in the line cycle (e.g., voltage shape, amplitude, etc.). Both the amplitude correction term and the current scaling term may include a constant (V_{system}) associated with a voltage of the system. For instance, V_{system} may be 240 for a 240 volt [V] system.

Aspects of the present disclosure provide for multiple technical effects and benefits. For instance, aspects of the present disclosure provide methods and systems that may compensate for non-ideal effects caused by line voltage irregularities (e.g. voltage fluctuation, irregular shape, etc.) when estimating electrical characteristics of an induction heating system. In addition, systems and methods of the present disclosure may provide for accurate estimation of the line current for irregularly shaped line voltages.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Referring now to the figures, example aspects of the present disclosure will be discussed in greater detail.

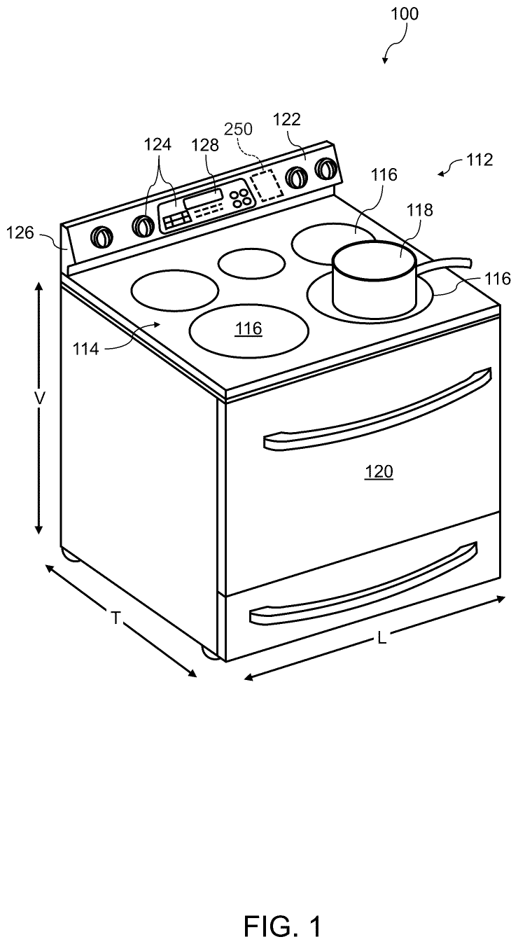

FIG. 1 depicts a perspective view of an induction cooking appliance 100. The induction cooking appliance 100 may include a cooktop 112, such as an induction cooktop. Induction cooking appliance 100 is provided by way of example only and is not intended to limit the present subject matter to the arrangement shown in FIG. 1. Thus, the present subject matter may be used with other induction cooking appliances such as oven appliances, single oven range appliances, double oven range appliances, standalone cooktop appliances, cooktop appliances without an oven, etc.

Induction cooking appliance 100 generally defines a vertical direction V, a lateral direction L, and a transverse direction T, each of which is mutually perpendicular, such that an orthogonal coordinate system is generally defined. A cooking surface 114 of cooktop 112 includes one or more induction heating elements 116. As shown in FIG. 1, cooktop 112 may include a plurality of heating elements 116. The heating elements 116 are generally positioned at, e.g., on or proximate to, the cooking surface 114. For the embodiment depicted, the cooktop 112 includes five heating elements 116 spaced along cooking surface 114. However, in other embodiments, the cooktop 112 may include any other suitable shape, configuration, and/or number of heating elements 116. In some embodiments, cooktop 112 may include a combination of other types of heating elements in addition to induction heating elements 116 as shown in FIG. 1. For example, in various embodiments, the cooktop 112 may include any other suitable type of heating elements in addition to the induction heating element, such as a resistive heating element or gas burners, etc.

Each of the induction heating elements 116 may be associated with one or more induction coils configured to inductively heat a load 118. Accordingly, load 118 (e.g., cooking vessel), such as a pot, pan, or the like, may be placed on an induction heating element 116 to heat the load 118 and cook or heat food items placed in load 118. The one or more induction coils of each heating element 116 may be associated with an inverter system configured to provide an alternating current to energize the one or more coils associated with the heating element 116.

Induction cooking appliance 100 may also include a door 120 that permits access to a cooking chamber (not shown) of induction cooking appliance 100, e.g., for cooking or baking of food items therein. A user interface 122 (e.g., control panel) having user input devices 124 may permit a user to make selections for cooking of food items. Although shown on a backsplash or back panel 126 of induction cooking appliance 100, user interface 122 may be positioned in any suitable location. User input devices 124 may include buttons, knobs, and the like, as well as combinations thereof, and/or user input devices 124 may be implemented on a remote user interface device such as a smartphone, tablet, etc. As an example, a user may manipulate one or more user input devices 124 to select a temperature and/or a heat or power output for each heating element 116. The selected temperature or heat output of heating element 116 affects the heat transferred to load 118 placed on heating element 116. The user interface 122 may also include a display 128.

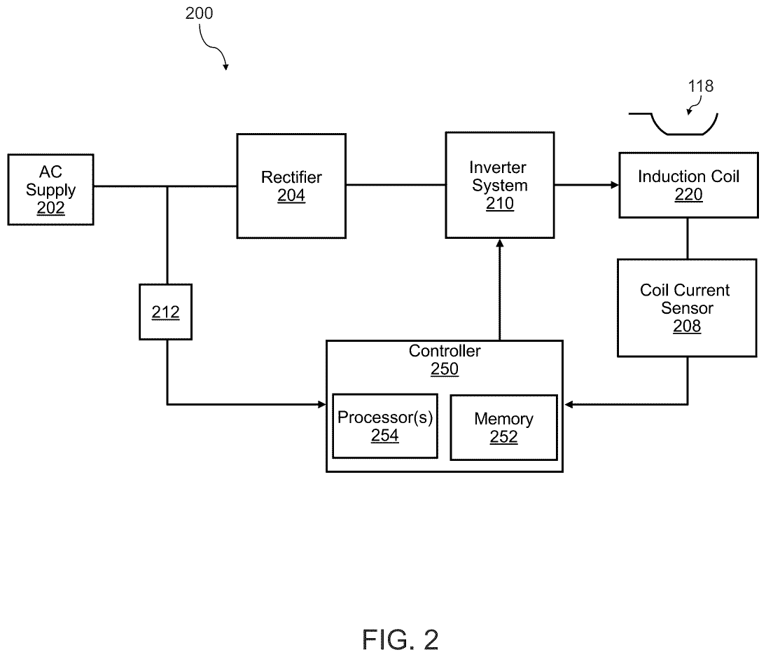

The induction cooking appliance 100 may include a controller 250 for controlling one or more of the plurality of heating elements 116. Specifically, the controller 250 may be operably coupled to the user interface 122 (e.g., user input devices 124 and/or display 128). Controller 250 may be operably coupled to each of the plurality of heating elements 116 for controlling a heating level of each of the plurality of heating elements 116 in response to one or more user inputs received through the user interface 122 and user input devices 124. The controller 250 may also provide output to the display 128, such as an indication of a selected power level, which heating element(s) 116 is or are activated, etc. Furthermore, as will be discussed in greater detail below, the controller 250 may be configured to control operation of an induction heating system such as induction heating system 200 (FIG. 2).

Referring now to FIG. 2, a block diagram depicting an induction heating system 200 according to example embodiments of the present disclosure is provided. While induction heating system 200 is generally discussed with reference to induction cooking appliance 100 of FIG. 1, those of ordinary skill in the art will understand that induction heating system 200 may be used in any suitable cooking system and/or appliance without deviating from the scope of the present disclosure.

As shown schematically in FIG. 2, induction heating system 200 may receive power from an AC power supply 202, which may provide a line voltage signal (e.g., alternating current (AC) power) as conventional 60 Hz 120 or 240 volt AC supplied by utility companies. Induction heating system 200 may include a rectifier circuit 204. Rectifier circuit 204 may receive the line voltage signal from AC power supply 202. Specifically, rectifier circuit 204 may rectify the line voltage signal from the AC power supply 202 to provide a rectified power. In some embodiments, rectifier circuit 204 may include additional circuitry, such as signal filtering and/or power factor correction circuitry to filter the line voltage signal.

Induction heating system 200 further includes an inverter system 210. Rectifier circuit 204 may be configured to provide the rectified power to the inverter system 210. Inverter system 210 may be any suitable inverter system, such as a half-bridge (HB) inverter system, a quasi-resonant (QR) inverter system, etc. Inverter system 210 is configured to provide an alternating current to an induction coil 220 to energize the coil 220. The induction coil 220, when supplied by the inverter system 210 with an alternating current, inductively heats the cooking vessel 118 (e.g., pan, load) or other object placed on, over, or near the induction coil 220. It will be understood that use of the term “cooking vessel” herein is merely exemplary, and that term will generally include any object of a suitable type that is capable of being heated by an induction heating coil.

The frequency of the current supplied to the induction coil 220 by inverter system 210 and hence the output power and coil current of the induction coil 220 is controlled by controller 250, which controls the switching frequency of the inverter system 210. Controller 250 may include a microcontroller and/or gate driver circuitry to drive individual transistors or switching devices of the inverter system 210. In some embodiments, the gate driver circuitry may be an external component to controller 250. For instance, controller 250 may provide switching signals to one or more gate drivers that control the inverter system 210 based on the switching signals. Controller 250 may include memory 252 and one or more processor(s) 254 such as microprocessors, CPUs or the like, such as general or special purpose microprocessors operable to execute programming instructions or micro-control code associated with operation of an induction cooking appliance, such as induction cooking appliance 100 of FIG. 1. Memory 252 may represent random access memory such as DRAM, or read only memory such as ROM or FLASH. In one embodiment, the processor(s) 254 executes programming instructions stored in memory 252. Memory 252 may be a separate component from controller 250 or may be included onboard controller 250.

In some embodiments, controller 250 may be communicatively coupled to a user interface of an appliance, such as user interface 122 of appliance 100 as shown in FIG. 1. As such, controller 250 may control inverter system 210 based on a desired power output or desired heat set by a user via the user interface.

Controller 250 may be configured to determine a coil current of induction coil 220. For example, Induction heating system 200 may further include a coil current sensor 208 configured to sense a coil current supplied to the induction heating coil 220 (e.g., current flowing through the induction coil 220). Current sensor 208 may include a current transformer, a current shunt monitor, a Hall-Effect sensor, or any suitable current sensing device.

Controller 250 may be configured to perform a coil current sampling routine over a coil current sampling time period to determine the coil current. For instance, the coil current sampling routine may include sampling the coil current (e.g., via current sensor 208) one or more times over the current sampling time period. The current sampling time period may correspond to a line cycle peak.

Controller 250 may be further configured to sample the line voltage. For example, controller 250 may be coupled to the AC power supply 202 (e.g., via conditioning circuit 212) such that controller 250 may sample the line voltage provided by the AC power supply 202. While FIG. 2 depicts controller 250 sampling the line voltage at a node between the AC power supply 202 and rectifier circuit 204, those of ordinary skill in the art will understand that controller 250 may sample the line voltage at any suitable location without deviating from the scope of the present disclosure. For instance, conditioning circuit 212 may alternatively be coupled to a node between rectifier circuit 204 and inverter system 210.

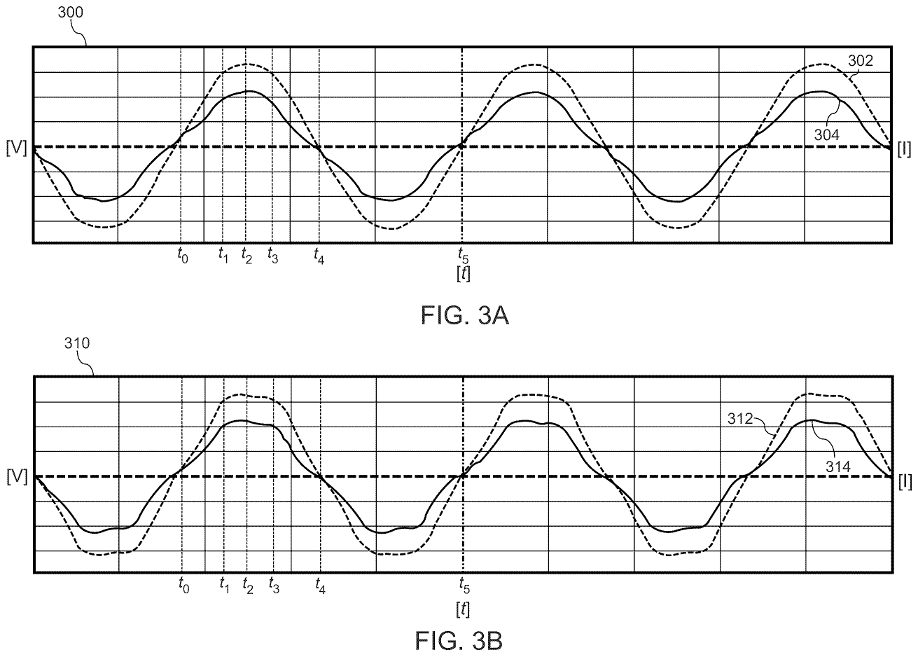

FIGS. 3A and 3B provide graphical representations of example signals of an induction heating system, such as induction heating system 200 of FIG. 2, according to example embodiments of the present disclosure. Plot 300 of FIG. 3A and plot 310 of FIG. 3B each provide an example line voltage 302, 312 and corresponding example line currents 304, 314 of an induction heating system over a period of time (t). Specifically, plot 300 of FIG. 3A provides an example generally sinusoidal line voltage 302 and corresponding line current 304, while plot 310 of FIG. 3A provides an example irregularly shaped (e.g., flat topped) line voltage 312 and corresponding line current 314.

Line voltages 302, 312 (e.g., and corresponding line currents 304, 314) may be characterized by a line cycle. For example, a line cycle of line voltage 302, 312 may be characterized by the period of time from the zero cross at t₀ to the zero cross at t₅, indicating a complete cycle of the alternating line voltage 302, 312. Each line cycle may have a first polarity (e.g., positive polarity) corresponding to a first line cycle peak (e.g., positive line cycle peak) and a second polarity (e.g., negative polarity) corresponding to a second line cycle peak (e.g., negative line cycle peak). For instance, a first polarity may be characterized by the period of time from the zero cross at t₀ to the zero cross at t₄, while a second polarity may be characterized by the period of time from the zero cross at t₄ to the zero cross at t₅.

As previously described with reference to FIG. 2, a coil current sampling routine may be performed during a current sampling time period corresponding to a line cycle peak. For example, as shown in FIGS. 3A and 3B, the coil current sampling time period may be from t₁ to t₃. As shown, the coil current sampling time period may be centered at the time t₂ associated with the line cycle peak. For instance, the duration of the coil current sampling time period may be about 0.1 milliseconds [ms], such that the coil current sampling routine may be initiated 0.05 ms before the line cycle peak at t₂ and end at 0.05 ms after the line cycle peak at t₂. In some embodiments, the coil current sampling time period (e.g., duration of the coil current sampling time period) may be approximately the same as two inverter switching periods.

A first line voltage value may be determined based at least in part on one or more first line voltage measurements sampled during the current sampling time period. In some embodiments, one or more first line voltage measurements may be a peak line voltage measurement sampled at a time (e.g., t₂) corresponding to the line cycle peak. Specifically, the peak line voltage measurement may be sampled after a delay period triggered by a zero cross. For instance, the zero cross at t₀ may trigger an interrupt of the controller 250. A delay time period (e.g., from t₀ to t₂) may correspond to a half-period of the line cycle such that the peak line voltage measurement is sampled at the peak of the line voltage 302, 312.

In alternative embodiments, the first line voltage value may be determined based at least in part on an average of a plurality of first line voltage measurements sampled during the current sampling time period. For instance, controller 250 may be configured to sample a first peak line voltage measurement at a time (e.g., t₁) corresponding to a start of the current sampling time period. Controller 250 may be further configured to sample a second peak line voltage measurement at a time (e.g., t₃) corresponding to an end of the current sampling time period. Accordingly, the first line voltage value may be determined by averaging the first peak line voltage measurement and the second peak line voltage measurement.

The first line voltage value may be determined based on a plurality of first line voltage measurements sampled throughout the current sampling time period (e.g., from t₁ to t₃). For instance, first line voltage measurements may be sampled any suitable number of times between a time (e.g., t₁) corresponding to a start of the current sampling time period and a time (e.g., t₃) corresponding to an end of the current sampling time period. For example, first line voltage measurements may be sampled at regular time intervals from t₁ to t₃. In addition, any appropriate algorithm (e.g., filtering, maximum, etc.) may be applied to the sampled first line voltage measurements to determine the first line voltage value.

Plot 300 of FIG. 3A provides a generally sinusoidal line voltage 302 while plot 310 of FIG. 3B provides an irregularly shaped (e.g., flat topped) line voltage 312. A peak line voltage measurement sampled at a time (e.g., t₂) corresponding to the line cycle peak may be the same for both line voltage 302 of plot 300 and line voltage 312 of plot 310. However, due to the irregularly shaped waveform of plot 310, the root mean square (RMS) line current value of line current 304 of plot 300 may be different than the RMS line current value of line current 314 of plot 310. Accordingly, a line current estimation based solely on a singular peak line voltage measurement may be skewed for irregularly shaped waveforms, such as those shown in plot 310 of FIG. 3B.

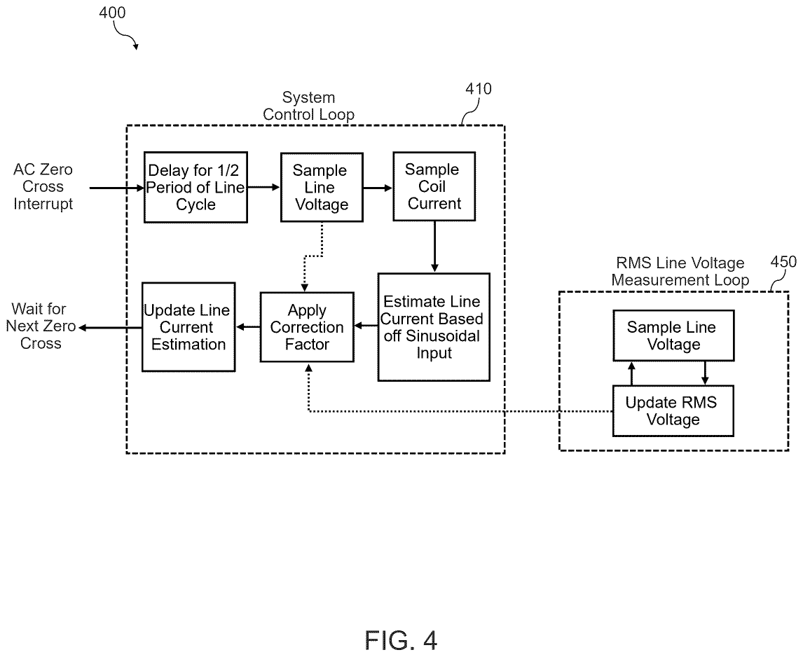

FIG. 4 provides a schematic implementation of an example control scheme 400 of an induction heating system according to example embodiments of the present disclosure. Although control scheme 400 is generally described with reference to induction heating system 200 of FIG. 2, those of ordinary skill in the art will understand that control scheme 400 may be implemented by any suitable induction heating system without deviating from the scope of the present disclosure. Specifically, control scheme 400 may be implemented by a controller, such as controller 250 (FIGS. 1 and 2).

As shown in FIG. 4, control scheme 400 may include a system control loop 410 and a line voltage measurement loop 450. Each loop 410, 450 may be performed by controller 250. As shown, both the system control loop 410 and the line voltage measurement loop 450 may include sampling the line voltage. Specifically, system control loop 410 may include determining a first line voltage value (e.g., peak line voltage value) based on one or more first line voltage measurement while line voltage measurement loop 450 may include determining a second line voltage value (e.g., RMS line voltage value) based on one or more second line voltage measurements.

As shown, system control loop 410 may be initiated by a zero cross of the line voltage. After a delay time period corresponding to a half period of the line cycle, controller 250 may be configured to sample the line voltage and the coil current. For example, controller 250 may control a coil current sensor 208 to perform a coil current sampling routine by sampling the coil current at a time corresponding to a peak of the line cycle after the zero cross. Similarly, the line voltage may be sampled (e.g., via conditioning circuit 212) during the coil current sampling routine, such as a the time corresponding to the peak of the line cycle after the zero cross.

Controller 250 may then determine a line current estimation based at least in part on the coil current sampling routine. For instance, the line current estimation may be determined based at least in part on one or more characteristics (e.g., phase, amplitude, etc.) of a coil current estimation determined during the coil current sampling routine. In addition, the line current estimation may be determined based on an assumed sinusoidal waveform of the line current.

Controller 250 may then apply a correction factor to the line current estimation to determine an adjusted line current estimation. For instance, a correction factor incorporating the first and second line voltage value may be applied to the line current estimation to determine the adjusted line current estimation. See below an example correction factor equation for determining an adjusted line current estimation:

$${I}_{line , corrected} = {I}_{line , sample} * \frac{\sqrt{2} * {V}_{System}}{{V}_{peak}} * \frac{{V}_{RMS}}{{V}_{System}}$$

As shown above, an adjusted line current estimation (I_{line,corrected}) may be determined based at least in part on the initial line current estimation (I_{line,sample}), the first line voltage value (Vₚₑₐₖ), and the second line voltage value (V_{RMS}). Specifically, the correction factor may include an amplitude correction term

$$( e . g . , \frac{\sqrt{2} * {V}_{System}}{{V}_{peak}} )$$

and a current scaling term

$$( e . g . , \frac{{V}_{RMS}}{{V}_{System}} )$$

to compensate for irregularities in the line cycle (e.g., voltage shape, amplitude, etc.). Both the amplitude correction term and the current scaling term may include a constant (V_{system}) associated with a voltage of the system. For instance, V_{system} may be 240 for a 240 volt [V] system. Accordingly, the controller 250 may determine the adjusted line voltage estimation based on a first line voltage value (e.g., the line voltage sampled during the coil current sampling routine), and the second line voltage value (e.g., RMS line voltage value) determined by line voltage measurement loop 450. Upon updating (e.g., adjusting) the line voltage estimation, control loop 410 may then wait for the next zero cross to repeat the loop.

As described above, line voltage measurement loop 450 may determine the second line voltage value based on one or more second line voltage measurements. Specifically, line voltage measurement loop 450 may be configured to continuously sample the line voltage to update the RMS line voltage value. For example, the line voltage measurement loop 450 may include sampling a plurality of second line voltage measurements during a polarity of the line cycle corresponding to the line cycle peak. After each second line voltage measurement is sampled, the RMS line voltage value may be updated. In some embodiments, the plurality of second line voltage measurements may be sampled over a polarity of the line cycle corresponding to the line cycle peak. For instance, as shown in FIGS. 3A and 3B, a polarity of the line cycle may be characterized as the time between a first zero cross at t₀ and a second zero cross at t₄. As shown, the polarity of the line cycle from t₀ to t₄ may correspond to the line cycle peak at t₂. Accordingly, the plurality of second line voltage measurements may be sampled at regular time intervals from t₀ to t₄.

Additionally and/or alternatively, the plurality of second line voltage measurements may be sampled over one or more line cycles. For example, an RMS line voltage value may be determined for each line cycle by sampling a plurality of second line voltage measurements over each line cycle. Upon determination of a line voltage value for a line cycle, the line voltage measurement may be averaged with one or more previously determined line voltage values.

In some embodiments, system control loop 410 may be performed at a different frequency than line voltage measurement loop 450. For example, the system control loop 410 may sample the one or more first line voltage measurements at a first frequency (e.g., first sampling rate), while the line voltage measurement loop 450 may sample the one or more second line voltage measurements at a second frequency (e.g., second sampling rate). In further embodiments, the first frequency at which the one or more first line voltage measurements are sampled at is greater than the second frequency at which the one or more second line voltage measurements are sampled at. For instance, the one or more first line voltage measurements may be sampled at a first frequency in a range of about 200 Kilohertz [KHz] to about 500 kHz, while the one or more second line voltage measurements may be sampled at a second frequency of about 600 hertz [Hz].

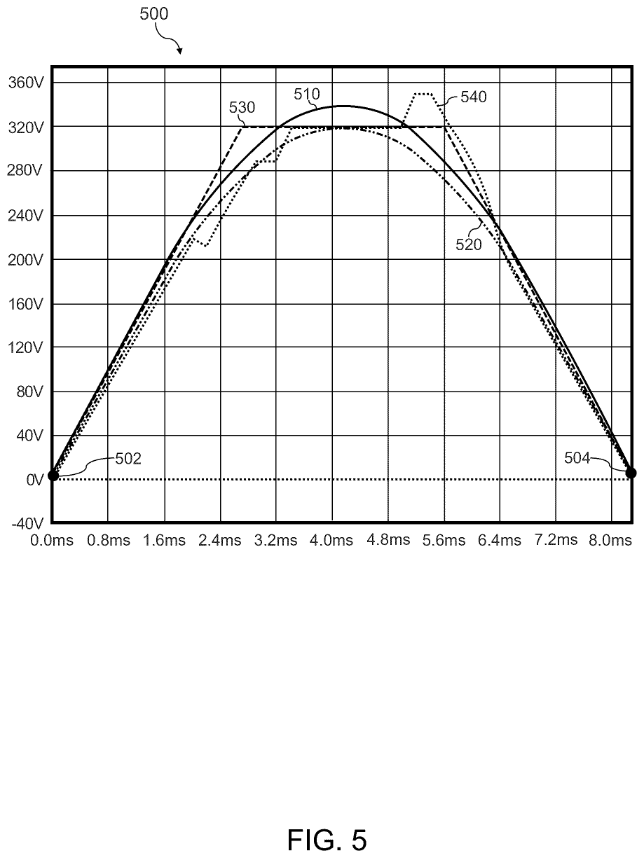

Referring now to FIG. 5, a graphical representation depicting example line voltages of an induction heating system, such as induction heating system 200 of FIG. 2, is provided according to example embodiments of the present disclosure. Specifically, plot 500 of FIG. 5 depicts example line voltages having various line cycle shapes and/or amplitudes. For instance, line voltage 510 depicts a sinusoidal line cycle, line voltage 520 depicts a low-amplitude sinusoidal line cycle, line voltage 530 depicts a flat-top line cycle, and line voltage 540 depicts a asymmetrical line voltage.

As previously described, controller 250 may be configured to control (e.g., drive) inverter system 210 based at least in part on a coil current setpoint determined based at least in part on a desired power output/desired heat set, for instance, by a user. For sinusoidal line voltages, such as line voltages 510, 520, an amplitude of the line voltage may be compensated for by adjusting a drive frequency of the inverter system 210. For instance, for a lower line voltage amplitude, controller 250 may drive the inverter system 210 harder to a lower frequency, thereby increasing the coil current such that the nominal current is met. However, when an irregularly shaped line voltage, such as line voltage 530, 540, is applied to the system, estimating the coil current based solely on the samples of the coil current at the midpoint between the two zero crosses 502, 504 and assuming a sinusoidal shape over the rest of the cycle may yield coil current estimates that are skewed. As such, a coil current estimation indicative of a coil current of the induction coil 220 may be adjusted based at least in part on the adjusted line current estimation. For example, table 1 (provided below) provides various values determined by an induction heating system according to example embodiments of the present disclosure based on the line voltages 510, 520, 530, 540 provided in plot 500.

TABLE 1

| Line | V_{line,RMS} | V_{line,peak} | I_{coil} | I_{coil,est} | I_{coil,est} | I_{coil,corrected} | I_{coil,corrected} |
|---|---|---|---|---|---|---|---|
| Voltage | [V] | [V] | [A] | [V] | Error | [A] | Error |
| 510 | 240 | 340 | 34.7 | 34.7 | 0.00% | 34.6 | −0.20% |
| 520 | 226 | 320 | 34.7 | 34.7 | 0.00% | 34.7 | −0.10% |
| 530 | 240 | 320 | 36.9 | 34.7 | −6.00% | 36.8 | −0.30% |
| 540 | 235 | 320 | 36 | 34.7 | −3.60% | 36 | 0.10% |

As shown in table 1 above, an RMS line voltage (V_{line,RMS}) and a peak line voltage (V_{line,peak}) may be determined for each line voltage 510, 520, 530, 540 shown in plot 500. Table 1 further shows the actual coil current (I coil) as an RMS value for each line voltage 510, 520, 530, 540. As previously described, a first coil current estimate (I_{coil,est}) may be determined for each line voltage 510, 520, 530, 540. The first coil current estimate (I_{coil,est}) may be determined from one or more coil current measurements sampled during a coil current sampling routine corresponding to a line cycle peak (e.g., coil current sampled at the midpoint between the two zero crosses 502, 504). As shown, the coil current estimation error (I_{coil,est} Error) may have a significant magnitude (e.g., −6%, −3.6%) for irregularly shaped line voltages 530, 540.

As such, the coil current estimate (I_{coil,est}) may be adjusted based at least in part on the RMS line voltage (V_{line,RMS}) and peak line voltage (V_{line,peak}) to determine an adjusted coil current estimate (I_{coil,corrected}). As shown in table 1, the adjusted coil current estimate (I_{coil,corrected}) may provide for significantly less estimation error (I_{coil,corrected} Error) for irregularly shaped line voltages 530, 540.

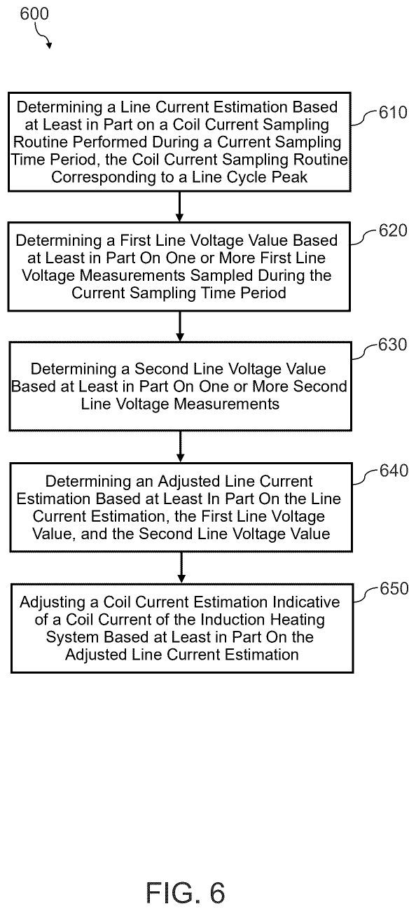

FIG. 6 provides a method 600 for estimating a line current in an induction heating system according to example embodiments of the present disclosure. Method 600 includes one or more steps that may be performed by a controller, such as controller 250 of FIGS. 1-2. In some embodiments, various method steps of method 600 may be performed (e.g., in part or in whole) by controller 250. It is noted that the order of steps within method 600 is for illustrative purposes. Except as otherwise indicated, one or more steps in method 600 may be changed, rearranged, performed in a different order, or otherwise modified without deviating from the scope of the present disclosure. While method 600 is generally described with reference to induction heating system 200 of FIG. 2 and induction cooking appliance 100 of FIG. 1, those of ordinary skill in the art will understand that method 600 may be performed or implemented by any suitable induction heating system and/or induction cooking appliance.

As shown in FIG. 6, method 600 may include, at step 610, determining a line current estimation based at least in part on a coil current sampling routine performed during a current sampling time period, the coil current sampling routine corresponding to a line cycle peak. For instance, controller 250 may, with coil current sensor 208, perform a coil current sampling routine corresponding to a line cycle peak during a current sampling time period. As such, controller 250 may determine a line current estimation based at least in part on a coil current measurement determined via the coil current sampling routine.

Method 600 may further include, at step 620, determining a first line voltage value based at least in part on one or more first line voltage measurements sampled during the current sampling time period. For example, controller 250 (e.g., via system control loop 410 (FIG. 4)) may determine a first line voltage value (e.g., peak line voltage value) based on one or more first line voltage measurements, such as measurements sampled at t₁, t₂, and/or t₃ (FIGS. 3A and 3B), sampled during a current sampling period (e.g., from t₁ to t₂). In some embodiments, the one or more first line voltage measurements comprises a peak line voltage measurement sampled at a first time corresponding to the line cycle peak, such as at time t₂ depicted in FIGS. 3A and 3B. In some embodiments, the one or more line voltage measurements include a first peak line voltage measurement sampled at a time corresponding to a start of the current sampling time period, such as at time t₁ depicted in FIGS. 3A and 3B and a second peak line voltage measurement sampled at a time corresponding to an end of the current sampling time period, such as at time t₂ depicted in FIGS. 3A and 3B. In some embodiments, the first line voltage value may be determined based on a plurality of first line voltage measurements sampled throughout the current sampling time period. For instance, as depicted in FIGS. 3A and 3B, first line voltage measurements may be sampled any suitable number of times between a time (e.g., t₁) corresponding to a start of the current sampling time period and a time (e.g., t₃) corresponding to an end of the current sampling time period. For example, first line voltage measurements may be sampled at regular time intervals from t₁ to t₃. In addition, any appropriate algorithm (e.g., filtering, maximum, etc.) may be applied to the sampled first line voltage measurements to determine the first line voltage value.

Method 600 may further include, at step 630, determining a second line voltage value based at least in part on one or more second line voltage measurements. For example, controller 250 (e.g., via line voltage measurement loop 450 (FIG. 4)) may determine a second line voltage value (e.g., RMS line voltage value) based on one or more second line voltage measurements. In some embodiments, the second line voltage value may be a root mean square (RMS) line voltage value. For instance, the RMS line voltage value may be determined based on a plurality of second line voltage measurements. In some embodiments, the plurality of second line voltage measurements may be sampled over a polarity of the line cycle corresponding to the line cycle peak. For example, referring back to FIG. 5, a polarity of a line cycle may be characterized between a first zero cross 502 and a second (e.g., sequential) zero cross 504. The corresponding line cycle peak may be defined as the midpoint (e.g., in time) between the zero crosses 502, 504. The second line voltage measurements may be sampled at a frequency of 600 Hz. For instance, a plurality of second measurements may be sampled at regular time intervals of about 1.6 ms (e.g., 1/600 Hz) from zero cross 502 to zero cross 504. In some embodiments, the RMS line voltage value is determined based at least in part on a plurality of second line voltage measurements sampled over a plurality of line cycles. For example, controller 250 may determine an RMS line voltage value for each line cycle by sampling a plurality of second line voltage measurements over each line cycle. Upon determination of a line voltage value for a line cycle, the line voltage measurement may be averaged with one or more previously determined line voltage values.

In some embodiments, the one or more first line voltage measurements are sampled at a first frequency and the one or more second line voltage measurements are sampled at a second frequency, the second frequency different than the first frequency. For instance, as shown in FIG. 4, the one or more first line voltage measurements (e.g., peak line voltage measurements) may be sampled at a first frequency as part of system control loop 410, while the one or more second line voltage measurements (e.g., RMS line voltage measurements) may be sampled at a second frequency as part of line voltage measurement loop 450. In some embodiments, the first frequency is greater than the second frequency. For instance, the one or more first line voltage measurements may be sampled at a first frequency in a range of about 200 Kilohertz [KHz] to about 500 kHz, while the one or more second line voltage measurements may be sampled at a second frequency of about 600 hertz [Hz].

Method 600 may further include, at step 640, determining an adjusted line current estimation based at least in part on the line current estimation, the first line voltage value, and the second line voltage value. For example, as described in reference to FIG. 4, controller 250 may determine an adjusted line current estimation (I_{line,corrected}) based at least in part on the line current estimation (I_{line,sample}), the first line voltage value (Vₚₑₐₖ), and the second line voltage value (V_{RMS}).

In some embodiments, method 600 may further include, at step 650, adjusting a coil current estimation indicative of a coil current of the induction heating system based at least in part on the adjusted line current estimation. For example, controller 250 may determine a coil current estimation by sampling the coil current during a current sampling routine. As shown in FIG. 5 and table 1, the coil current estimation may be adjusted based at least in part on the adjusted line current estimation.

One example aspect of the present disclosure is directed to a method for estimating a line current in an induction heating system. The method includes determining a line current estimation based at least in part on a coil current sampling routine performed during a current sampling time period, the coil current sampling routine corresponding to a line cycle peak. The method further includes determining a first line voltage value based at least in part on one or more first line voltage measurements sampled during the current sampling time period. The method further includes determining a second line voltage value based at least in part on one or more second line voltage measurements. The method further includes determining an adjusted line current estimation based at least in part on the line current estimation, the first line voltage value, and the second line voltage value.

In some examples, the one or more first line voltage measurements comprises a peak line voltage measurement sampled at a first time corresponding to the line cycle peak.

In some examples, the second line voltage value comprises a root mean square (RMS) line voltage value.

In some examples, the RMS line voltage value is determined based at least in part on a plurality of second line voltage measurements sampled over a polarity of the line cycle corresponding to the line cycle peak.

In some examples, the RMS line voltage value is determined based at least in part on a plurality of second line voltage measurements sampled over a plurality of line cycles.

In some examples, the one or more first line voltage measurements are sampled at a first frequency and the one or more second line voltage measurements are sampled at a second frequency, the second frequency different than the first frequency.

In some examples, the first frequency is greater than the second frequency.

In some examples, the one or more first line voltage measurements include a first peak line voltage measurement sampled at a time corresponding to a start of the current sampling time period, and a second peak line voltage measurement sampled at a time corresponding to an end of the current sampling time period. In some examples, the first line voltage value is determined based at least in part on an average of the first peak line voltage measurement and the second peak line voltage measurement.

In some examples, the method further includes adjusting a coil current estimation indicative of a coil current of the induction heating system based at least in part on the adjusted line current estimation.

In some examples, the peak line voltage measurement is sampled a delay time period after a zero cross of the line cycle.

Another example aspect of the present disclosure is directed to an induction heating system of an induction cooking appliance. The induction heating system includes an induction coil configured to inductively heat a load. The induction heating system further includes an inverter configured to provide power to the induction coil. The induction heating system further includes a controller. The controller is configured to determine a line current estimation based at least in part on a coil current sampling routine performed during a current sampling time period, the coil current sampling routine corresponding to a line cycle peak. The controller is further configured to determine a first line voltage value based at least in part on one or more first line voltage measurements sampled during the current sampling time period. The controller is further configured to determine a second line voltage value based at least in part on one or more second line voltage measurements. The controller is further configured to determine an adjusted line current estimation based at least in part on the line current estimation, the first line voltage value, and the second line voltage value.

In some examples, the one or more first line voltage measurements comprises a peak line voltage measurement sampled at a first time corresponding to the line cycle peak.

In some examples, the second line voltage value comprises a root mean square (RMS) line voltage value determined based at least in part on a plurality of second line voltage measurements sampled over a polarity of the line cycle corresponding to the line cycle peak.

In some examples, the one or more first line voltage measurements are sampled at a first frequency and the one or more second line voltage measurements are sampled at a second frequency, wherein the first frequency is greater than the second frequency.

In some examples, the controller is further configured to adjust a coil current estimation indicative of a coil current of the induction heating system based at least in part on the adjusted line current estimation.

Another example aspect of the present disclosure is directed to an induction cooking appliance. The induction cooking appliance includes a user interface. The induction cooking appliance further includes an induction heating system. The induction heating system includes an induction coil configured to inductively heat a load. The induction heating system further includes an inverter configured to provide power to the induction coil. The induction heating system further includes a controller. The controller is configured to determine a line current estimation based at least in part on a coil current sampling routine performed during a current sampling time period, the coil current sampling routine corresponding to a line cycle peak. The controller is further configured to determine a first line voltage value based at least in part on one or more first line voltage measurements sampled during the current sampling time period. The controller is further configured to determine a second line voltage value based at least in part on one or more second line voltage measurements. The controller is further configured to determine an adjusted line current estimation based at least in part on the line current estimation, the first line voltage value, and the second line voltage value.

In some examples, the one or more first line voltage measurements are sampled at a first frequency and the one or more second line voltage measurements are sampled at a second frequency, wherein the first frequency is greater than the second frequency.

In some examples, the one or more first line voltage measurements include a first peak line voltage measurement sampled at a time corresponding to a start of the current sampling time period, and a second peak line voltage measurement sampled at a time corresponding to an end of the current sampling time period. In some examples, the first line voltage value is determined based at least in part on an average of the first peak line voltage measurement and the second peak line voltage measurement.

In some examples, the second line voltage value comprises a root mean square (RMS) line voltage value determined based at least in part on a plurality of second line voltage measurements sampled over a polarity of the line cycle corresponding to the line cycle peak.

In some examples, the controller is further configured to adjust a coil current estimation indicative of a coil current of the induction heating system based at least in part on the adjusted line current estimation.

Although specific features of various embodiments may be shown in some drawings and not in others, this is for convenience only. In accordance with the principles of the present disclosure, any feature of a drawing can be referenced and/or claimed in combination with any feature of any other drawing.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for estimating a line current in an induction heating system, the method comprising:
determining a line current estimation based at least in part on a coil current sampling routine performed during a current sampling time period, the coil current sampling routine corresponding to a line cycle peak;
determining a first line voltage value based at least in part on one or more first line voltage measurements sampled during the current sampling time period;
determining a second line voltage value based at least in part on one or more second line voltage measurements; and
determining an adjusted line current estimation based at least in part on the line current estimation, the first line voltage value, and the second line voltage value.

2. The method of claim 1, wherein the one or more first line voltage measurements comprises a peak line voltage measurement sampled at a first time corresponding to the line cycle peak.

3. The method of claim 1, wherein the second line voltage value comprises a root mean square (RMS) line voltage value.

4. The method of claim 3, wherein the RMS line voltage value is determined based at least in part on a plurality of second line voltage measurements sampled over a polarity of the line cycle corresponding to the line cycle peak.

5. The method of claim 4, wherein the RMS line voltage value is determined based at least in part on a plurality of second line voltage measurements sampled over a plurality of line cycles.

6. The method of claim 1, wherein the one or more first line voltage measurements are sampled at a first frequency and the one or more second line voltage measurements are sampled at a second frequency, the second frequency different than the first frequency.

7. The method of claim 6, wherein the first frequency is greater than the second frequency.

8. The method of claim 1, wherein the one or more first line voltage measurements comprises:
a first peak line voltage measurement sampled at a time corresponding to a start of the current sampling time period; and
a second peak line voltage measurement sampled at a time corresponding to an end of the current sampling time period,
wherein the first line voltage value is determined based at least in part on an average of the first peak line voltage measurement and the second peak line voltage measurement.

9. The method of claim 1, further comprising:
adjusting a coil current estimation indicative of a coil current of the induction heating system based at least in part on the adjusted line current estimation.

10. The method of claim 2, wherein the peak line voltage measurement is sampled a delay time period after a zero cross of the line cycle.

11. An induction heating system of an induction cooking appliance, the induction heating system comprising:
an induction coil configured to inductively heat a load;
an inverter configured to provide power to the induction coil;
a controller configured to:
determine a line current estimation based at least in part on a coil current sampling routine performed during a current sampling time period, the coil current sampling routine corresponding to a line cycle peak;
determine a first line voltage value based at least in part on one or more first line voltage measurements sampled during the current sampling time period;
determine a second line voltage value based at least in part on one or more second line voltage measurements; and
determine an adjusted line current estimation based at least in part on the line current estimation, the first line voltage value, and the second line voltage value.

12. The induction heating system of claim 11, wherein the one or more first line voltage measurements comprises a peak line voltage measurement sampled at a first time corresponding to the line cycle peak.

13. The induction heating system of claim 11, wherein the second line voltage value comprises a root mean square (RMS) line voltage value determined based at least in part on a plurality of second line voltage measurements sampled over a polarity of the line cycle corresponding to the line cycle peak.

14. The induction heating system of claim 11, wherein the one or more first line voltage measurements are sampled at a first frequency and the one or more second line voltage measurements are sampled at a second frequency, wherein the first frequency is greater than the second frequency.

15. The induction heating system of claim 14, wherein the controller is further configured to:
adjust a coil current estimation indicative of a coil current of the induction heating system based at least in part on the adjusted line current estimation.

16. An induction cooking appliance, comprising:
a user interface; and
an induction heating system, comprising:
an induction coil configured to inductively heat a load;
an inverter configured to provide power to the induction coil;
a controller configured to:
determine a line current estimation based at least in part on a coil current sampling routine performed during a current sampling time period, the coil current sampling routine corresponding to a line cycle peak;
determine a first line voltage value based at least in part on one or more first line voltage measurements sampled during the current sampling time period;
determine a second line voltage value based at least in part on one or more second line voltage measurements; and
determine an adjusted line current estimation based at least in part on the line current estimation, the first line voltage value, and the second line voltage value.

17. The induction cooking appliance of claim 16, wherein the one or more first line voltage measurements are sampled at a first frequency and the one or more second line voltage measurements are sampled at a second frequency, wherein the first frequency is greater than the second frequency.

18. The induction cooking appliance of claim 16, wherein the one or more first line voltage measurements comprises:
a first peak line voltage measurement sampled at a time corresponding to a start of the current sampling time period; and
a second peak line voltage measurement sampled at a time corresponding to an end of the current sampling time period,
wherein the first line voltage value is determined based at least in part on an average of the first peak line voltage measurement and the second peak line voltage measurement.

19. The induction cooking appliance of claim 18, wherein the second line voltage value comprises a root mean square (RMS) line voltage value determined based at least in part on a plurality of second line voltage measurements sampled over a polarity of the line cycle corresponding to the line cycle peak.

20. The induction cooking appliance of claim 16, wherein the controller is further configured to:
adjust a coil current estimation indicative of a coil current of the induction heating system based at least in part on the adjusted line current estimation.
